(19) United States
(12) Patent Application Publication
(10) Pub. No.: US 2014/0233082 A1
(43) Pub. Date: Aug. 21, 2014

(54) Multi Spectral Vision Aid

(71) Applicant: House of Innovation B.V., Doesburg (NL)

(72) Inventors: Franciscus Jozef Fredericus Maria Smeets, Doesburg (NL); Dirk Van Toledo, Waalwijk (NL)

(73) Assignee: House of Innovation B.V., Doesburg (NL)

(21) Appl. No.: 14/266,150

(22) Filed: Apr. 30, 2014

Related U.S. Application Data
(63) Continuation of application No. PCT/NL12/00065, filed on Oct. 31, 2012.

(30) Foreign Application Priority Data
Oct. 31, 2011 (NL) 2007687

(51) Int. Cl. G02B 27/26; G02B 27/22

(52) U.S. Cl. CPC G02B 27/26; G02B 27/2264
USPC 359/238

(57) ABSTRACT

A multi spectrum vision aid, use thereof, and a method using the aid. The present invention relates in a first aspect to a multi spectrum vision aid comprising at least two transparent elements, in a second aspect to use thereof and in a third aspect to a method of distinguishing elements in a population.

### CROSS-REFERENCE TO RELATED APPLICATIONS

This application is a continuation application of International Patent Application No. PCT/NL2012/000065, entitled “Multi spectral Vision Aid”, filed on Oct. 31, 2012, which application claims priority to and the benefit of Netherlands Patent Application Serial No. 2007687, filed on Oct. 31, 2011, and the specifications and claims thereof are incorporated herein by reference.

### STATEMENT REGARING FEDERALLY SPONOSRED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention is in the field of multi spectrum vision aid, use thereof, and a method of using the aid.

2. Description of Related Art

Liquid crystals (LCs) are a state of matter that have properties between those of a conventional liquid and those of a solid crystal. For instance, an LC may flow like a liquid, but its molecules may be oriented in a crystal-like way. There are many different types of LC phases, which can be distinguished by their different optical properties (such as birefringence). When viewed under a microscope using a polarized light source, different liquid crystal phases will appear to have distinct textures. The contrasting areas in the textures correspond to domains where the LC molecules are oriented in different directions. Within a domain, however, the molecules are well ordered. LC materials may not always be in an LC phase.

Liquid crystals can be divided into thermotropic, lyotropic and metallotropic phases.

Examples of liquid crystals can be found both in the natural world and in technological applications. Most modern electronic displays are liquid crystal based.

The various LC phases (called mesophases) can be characterized by the type of ordering. One can distinguish positional order (whether molecules are arranged in any sort of ordered lattice) and orientational order (whether molecules are mostly pointing in the same direction), and moreover order can be either short-range (only between molecules close to each other) or long-range (extending to larger, sometimes macroscopic, dimensions). Most thermotropic LCs will have an isotropic phase at high temperature.

The ordering of liquid crystalline phases is extensive on the molecular scale. However some techniques, such as the use of boundaries or an applied electric field, can be used to enforce a single ordered domain in a macroscopic liquid crystal sample. The ordering in a liquid crystal might extend along only one dimension, with the material being essentially disordered in the other two directions.

Thermotropic phases are those that occur in a certain temperature range. Many thermotropic LCs exhibit a variety of phases as temperature is changed. An example of a compound displaying thermotropic LC behavior is para-azoxyanisole.

One of the most common LC phases is the nematic. In a nematic phase, the calamitic or rod-shaped organic molecules have no positional order, but they self-align to have long-range directional order with their long axes roughly parallel. Most nematics are uniaxial: they have one axis that is longer and preferred, with the other two being equivalent. However, some liquid crystals are biaxial nematics, meaning that in addition to orienting their long axis, they also orient along a secondary axis. Nematics have fluidity similar to that of ordinary (isotropic) liquids but they can be easily aligned by an external magnetic or electric field. Aligned nematics have the optical properties of uniaxial crystals and this makes them extremely useful in liquid crystal displays (LCD).

Liquid crystals find wide use in liquid crystal displays, which rely on the optical properties of certain liquid crystalline substances in the presence or absence of an electric field. In a typical device, a liquid crystal layer (typically 5-20 μm thick) sits between two polarizers that are crossed (oriented at 90° to one another). The liquid crystal alignment is chosen so that its relaxed phase is a twisted one (see

Twisted nematic field effect). This twisted phase reorients light that has passed through the first polarizer, allowing its transmission through the second polarizer (and reflected back to the observer if a reflector is provided). The device thus appears transparent. When an electric field is applied to the LC layer, the long molecular axes tend to align parallel to the electric field thus gradually untwisting in the center of the liquid crystal layer. In this state, the LC molecules do not reorient light, so the light polarized at the first polarizer is absorbed at the second polarizer, and the device loses transparency with increasing voltage. In this way, the electric field can be used to make a pixel switch between transparent or opaque on command. Color LCD systems use the same technique, with color filters used to generate red, green, and blue pixels. Similar principles can be used to make other liquid crystal based optical devices.

Liquid crystal tuneable filters are used as electrooptical devices, e.g. in hyperspectral imaging.

Thermotropic chiral LCs whose pitch varies strongly with temperature can be used as crude liquid crystal thermometers, since the color of the material will change as the pitch is changed. Liquid crystal color transitions are used on many aquarium and pool thermometers as well as on thermometers for infants or baths. Other liquid crystal materials change color when stretched or stressed.

Liquid crystal tuneable filters (LCTFs) are solid-state optical filters that use electronically controlled liquid crystal (LC) elements to transmit a selectable wavelength of light and exclude others. LCTFs are known for very high image quality and relatively easy integration with regard to optical system design and software control but relatively low peak transmission values due to the use of multiple polarizing elements. This can be mitigated in some instances by using wider bandpass designs, since a wider bandpass results in more light travelling through the filter. Some LCTFs are limited to a small number of fixed wavelengths such as the red, green, and blue (RGB) colors while others can be tuned in small increments over a wide range of wavelengths such as the visible or near-infrared spectrum from about 400 to the current limit of about 2450 nm. The tuning speed of LCTFs varies by manufacturer and design, but is generally in the few dozen millisecond range.

LCTFs are often used in multispectral imaging or hyperspectral imaging systems because of their high image quality and rapid tuning over a broad spectral range.

Another type of solid-state tuneable filter is the Acousto Optic Tuneable Filter (AOTF), based on the principles of the acousto-optic modulator.

A multi-spectral image is one that captures image data at specific frequencies across the electromagnetic spectrum. The wavelengths may be separated by filters or by the use of instruments that are sensitive to particular wavelengths, including light from frequencies beyond the visible light range, such as infrared. Spectral imaging can allow extraction of additional information that the human eye fails to capture with its receptors for red, green and blue.

The availability of wavelengths for remote sensing and imaging is limited by infrared window and optical window. For different purposes, different combinations of spectral bands can be used. They are usually represented with red, green, and blue channels. Some combinations are given next. True-color—uses only red, green, and blue channels, mapped to their respective colors. A plain color photograph—good for analyzing man-made objects. Easy to understand for beginner analysts.

Green-red-infrared, where blue channel is replaced with near infrared—vegetation, highly reflective in near IR, then shows as blue. This combination is often used for detection of vegetation and camouflage.

Blue-nearIR-midIR, where blue channel uses visible blue, green uses near-infrared (so vegetation stays green), and mid-infrared is shown as red—such images allow seeing the water depth, vegetation coverage, soil moisture content, and presence of fires, all in a single image.

Many other combinations are in use. Near infrared is often shown as red, making vegetation covered areas appear red.

Hyperspectral imaging collects and processes information from across the electromagnetic spectrum. Much as the human eye sees visible light in three bands (red, green, and blue), spectral imaging divides the spectrum into many more bands. This technique of dividing images into bands can be extended beyond the visible.

Hyperspectral sensors look at objects using a vast portion of the electromagnetic spectrum. Certain objects leave unique ‘fingerprints’ across the electromagnetic spectrum. These ‘fingerprints’ are known as spectral signatures and enable identification of the materials that make up a scanned object. Hyperspectral sensors collect information as a set of ‘images’.

Hyperspectral imaging is part of a class of techniques commonly referred to as spectral imaging or spectral analysis. Hyperspectral imaging is related to multispectral imaging. The distinction between hyper- and multi-spectral is sometimes based on an arbitrary “number of bands” or on the type of measurement, depending on what is appropriate to the purpose.

Multispectral deals with several images at discrete and somewhat narrow bands. The “discrete and somewhat narrow” is what distinguishes multispectral in the visible from color photography. A multispectral sensor may have many bands covering the spectrum from the visible to the long wave infrared. Multispectral images do not produce the “spectrum” of an object.

Hyperspectral deals with imaging narrow spectral bands over a contiguous spectral range, and produce the spectra of all pixels in the scene. So a sensor with only 20 bands can also be hyperspectral when it covers the range from 500 to 700 nm with 20 10-nm wide bands. (While a sensor with 20 discrete bands covering the VIS, NIR, SWIR, MWIR, and LWIR would be considered multispectral.)

Although the costs of acquiring hyperspectral images is typically high, for specific crops and in specific climates hyperspectral remote sensing is used more and more for monitoring the development and health of crops.

By hyperspectral mapping, an entire spectrum at each mapping point is acquired, and a quantitative analysis can be performed by computer post-processing of the data, and a quantitative map of e.g. iron content produced.

The primary disadvantages associated with e.g. hyperspectral data are cost and complexity. Fast computers, sensitive detectors, and large data storage capacities are needed for analyzing hyperspectral data. Significant data storage capacity is necessary since hyperspectral cubes are large multi-dimensional datasets, potentially exceeding hundreds of megabytes. All of these factors greatly increase the cost of acquiring and processing hyperspectral data. As a relatively new analytical technique, the full potential of hyperspectral imaging has not yet been realized.

U.S. Pat. No. 6,031,588 (A) recites a device featuring liquid crystals for local reduction of the intensity of incident light. This device protects the eyes or the video camera against blinding, or the light-sensitive medium against local damage by automatically reducing the intensity of the incident light emitted by brightly illuminated objects, while the brightness of poorly illuminated objects is not suppressed. The device uses optically addressed spatial light modulators (OASLM) on the basis of a semitransparent photoconducting film in contact with ferroelectric liquid crystals (FLC). The DHF effect (deformation of the helix structure) in ferroelectric liquid crystals (FLC) with helix-shaped structure is used here. The drive voltage has a frequency of 102 to 103 Hz at an amplitude of ±20 V, which is 10-50 times higher than that of devices operating with nematic liquid crystals. The device allows moving objects to be observed against the background of a bright light source. A switchable shutter on the basis of ferroelectric liquid crystals (FLC) is used at a molecular inclination of θₒ≠45°. To increase the average transmission of the device, a second FLC layer with chiral smectic A or C phase with a switchable molecular inclination of θ_{c}=45°−θₒ or θ_{c}=θₒ is used.

U.S. Pat. No. 6,760,080 (B1) recites a light modulating cell assembly especially suitable as eyewear including a detector and a light blocking arrangement at least partially surrounding a detector for allowing only light from a limited range of ambient directions to directly reaching said detector. In accordance with another embodiment there is a light transmissivity control arrangement including auxiliary means for controlling the state of said light modulating medium.

US 2008024858 (A1) recites an apparatus for enhancing vision of a user includes a focal modulation device, which is adapted to focus light from objects in a field of view of the user onto the retina while alternating between at least first and second focal states that are characterized by different, respective first and second focal depths, at a rate in excess of a flicker-fusion frequency of the user.

U.S. Pat. No. 5,184,156 (A) recites glasses with multi-layered, color-switchable lenses and for blocking harmful radiation including a rim. The rim contains a photosensor, a color-changing switch, a dry-cell power source, solar cells, an electronic driver unit, and an electronic circuit. When the photosensor determines that the intensity of incident radiation falls above or below the specified threshold, an amplified signal is sent via the circuit to the electronic driver unit which supplies layers with voltages which cause the color-switchable lenses to change their spectral transmittance characteristics. As harmful radiation needs to be blocked both lenses switch simultaneously, that is once from an inactive state to an active state, or vice versa, upon triggering. The states are (always) the same for both lenses.

U.S. Pat. No. 6,992,809 (B1) recites a single hyper-spectral imaging filter with serial stages along an optical signal path in a Solc filter configuration. Angularly distributed retarder elements of equal birefringence are stacked in each stage, with a polarizer between stages. The retarders can include tuneable, fixed and/or combined tuneable and fixed birefringences. Although the retardations are equal within each stage, distinctly different retardations are used for two or more different stages. This causes some stages to pass narrow band pass peaks and other stages to have widely spaced bandpass peaks. The transmission functions of the serial stages are superimposed with selected preferably-tuneable peaks coinciding. The resulting conjugate filter has a high finesse ratio, and good out of band rejection.

WO9402879 (A1) recites discretely and continuously tuneable single and multiple-stage polarization interference single filters employing chiral smectic liquid crystal cells as electronically rotatable retarders are provided. Discretely tuneable filters include those which employ bistable surface-stabilized ferroelectric liquid crystal cells. Continuously tuneable filters include those that imply chiral smectic A ferroelectric liquid crystal cells. Single stage filters include fixed birefringent elements in combination with chiral smectic liquid crystal cells or can include chiral smectic liquid crystal cells in combination with fixed birefringent elements. Blocking filters useful for color generation and color displays are also provided. The FLC filters provided can be temporally multiplexed.

US 2007209393 (A1) recites a method of constructing a curved optical device including assembling of at least one cell having opposed flexible substrates with a controlled distance there between to form a gap adapted to receive a fluid. Such is largely irrelevant to the present invention.

WO2011127015 (A1) recites an electronically controllable optical device which includes a cell maintaining an electro-optically controllable material, a photosensor associated with the cell, wherein the photosensor generates an input signal based on ambient light level, and a control circuit which receives the input signal and generates at least one output signal received by the cell. The device also includes a single switch connected to the control circuit, wherein actuation of the switch in predetermined sequences enables at least two of the following features of the device, a state change of the material, a system change between auto and manual modes, or a threshold value change for generation of the ambient light input signal, a device color change, a device tint change or a reset of the threshold value to the original factory setting. Methods of operation for the device are also provided. A control apparatus for the device is also disclosed. The document recite not more than a way of “one-button switch set up for multiple functions”.

All of the above relate to complex systems, not easy to be used in practical life. Further the documents typically relate to filtering and/or switching between states, providing typically only two states. The state is than maintained. Only when e.g. triggered the state is reversed to an initial state.

Also the systems are relatively expensive.

Further, the systems are not adapted for specific use, or difficult to adapt thereto.

The present invention therefore relates to a multi spectrum vision aid that overcomes one or more of the above disadvantages, without jeopardizing functionality and advantages.

### BRIEF SUMMARY OF THE INVENTION

The present invention relates to a multi spectrum vision aid according to claim 1, use of said multi spectrum vision aid, and a method for improving yield.

The present multi spectrum vision aid provides stereoscopic images. Such is a huge advantage as by providing a different image to each eye of a user, spectral differences between elements in a population are detected with ease. For instance, vegetables ready to harvest are distinguished from vegetables not ready yet.

It is important to obtain a multi spectrum that is more than one spectrum, and making use of the multi spectrum in order to identify differences between e.g. elements of a population, the difference being visible as spectral differences.

In order to increase the spectral differences an analyzer and/or polarizer may be added. However, such presence typically results in a decrease of intensity. Therefore, depending on an envisaged application, the analyzer and/or polarizer may be discarded.

The multi spectrum vision aid comprises at least two transparent elements that is elements that allow for passage of at least part of the spectrum for a large percentage, i.e. 30% or more, preferably 50% or more, such as 90% or more. There may also be more elements, such as rotating elements, exchanging elements, etc. An aid with two elements is for certain applications preferred, in view of, e.g., its simplicity.

It is important for capturing an image that the combined filter is modulated, such as by modulating the frequency being filtered thereof. Such as modulation is performed with a certain frequency itself, e.g., in the order of 3-500 Hz, such as from 10-100 Hz, e.g. 25-50 Hz. Modulating allows the eye to capture features not to be caught without modulation, e.g. spectral differences. Thereby elements, e.g., ripe fruit, can be selected in a population. In other words spectral transmission characteristics of a filter may be varied.

Typically modulation is between a first status, e.g. using a first filter allowing a first frequency range to pass, and a second status, similarly using a second filter. The first and second filter may partly overlap. Modulation may also be established between three or more statuses, depending on the specific requirements of an application. Modulation may also be different between a first and second transparent element. At least one transparent element is however modulated. A simple version of the present vision aid has only one transparent element being modulated, the other transparent element may then be a glass. In other words the present modulator can vary transmission characteristics of the at least two filters in a repetitive and continuous mode, such that a predetermined combination of variations is obtained.

On the one hand, preferably polarized light is used to improve the effect of the vision aid, on the other hand the transmittance of a typical polarizer and/or analyzer reduces the intensity of an image.

Typically a full range of available “light” spectrum may be used. Depending on specific requirements only part of the spectrum may be used.

In view of available light a polarizer, and likewise an analyzer, may be preferred, in order to optimize performance of the multi spectrum vision aid, e.g. in terms of intensity, contrast, filtering, etc.

The present vision aid may be used to select elements in a population, or be used otherwise.

Thereby the present invention provides a solution to one or more of the above mentioned problems.

Advantages of the present description are detailed throughout the description.

### DETAILED DESCRIPTION OF THE INVENTION

The present invention relates in a first aspect to a multi spectrum vision aid according to claim 1.

The repeated order of claim 1 may be selected in a time limited or infinite modus

The repeated order of claim 1 may comprise time modulated spectral filtering, which allows a regular and repeated sequence of specific (bands of) frequencies, which may be tuneable if required. It may also be tuneable for a user of the device to optimize observation and/or to optimize comfort of observation.

The modulator is typically in operation during a time of at least two cycles, more typical during a large number of cycles, such as a few hundred. The modulator is aimed at providing a sequence of potentially different images, in that objects remain the same and an optical spectrum thereof differs by applying the combined filter in different statuses. Typically the statuses are provided in a predetermined sequence.

In an example of the present multi spectrum vision aid the frequency is from 50-1000 Hz, preferably from 75-500 Hz, more preferably from 100-250 Hz, such as from 120-150 Hz, or wherein the frequency is from 2-35 Hz, preferably from 3-25 Hz, more preferably from 6-15 Hz, such as from 10-12 Hz. That is in one example the frequency is relatively fast. A human eye is not, or hardly, capable of following and separating images formed. As a consequence the human eye will experience a continuous image, which may be considered as a superposition of separate images formed by applying different statuses. In another example the human eye is capable of experiencing changing images, and therefor capable of detecting potential differences in images formed in sequence. Depending on e.g. an envisaged application and boundary conditions a slower of faster frequency may be applied.

In an example of the present multi spectrum vision aid the modulator is adapted to alternate between at least three statuses, preferably 4-10 statuses, such as 6-8 statuses, and/or wherein the modulator is adapted to provide an idle status during a period of time in a range of 10 msec-0.5 sec. For instance, the aid may vary between six statuses. Each status may be maintained over a given period of time, such as 2-100 msec, followed by a next sequence for a given period of time, until after a sixth status the first status is maintained again. Periods of time may be similar or the same, or may be different. In between a first and second status an idle time may be provided. Also an idle time may vary, such as from 0.1-1000 msec.

In an example the present invention relates to a multi spectrum vision aid wherein the aid comprises two transparent elements, such as at least one element per eye, preferably at least two elements which have a substantially different combined filter, wherein the aid is preferably provided as glasses, enabling stereoscopic vision.

A huge advantage is that thereby stereoscopic vision is provided. Such allows for easy detection of specific features, e.g., ripe fruit. Thereby selection of elements, based on certain criteria, within a population is made possible. Such significantly increases yield of high quality products, storage life thereof, etc.

In an example the present invention relates to a multi spectrum vision aid further comprising at least one modulator per element, for independently modulating an element, wherein the modulator is adapted to modulate the combined filter, wherein the at least one modulator is preferably a thermal modulator, an electrical modulator, a chemical modulator, or a combination thereof, and one or more of a thermal, an electrical, and a chemical supply for the at least one modulator, and a driver for directing the at least one modulator, and optionally a read-out unit for the at least one modulator.

Depending on the type of filter the modulator is one of three mentioned above, or a combination thereof.

Typically a modulator has a supply in order to activate the modulator.

Also the modulator has a driver, in order to select e.g. frequency of modulation, frequency of filters, switching the modulator, etc.

A modulator may further comprise a read-out unit.

In an example the present invention relates to a multi spectrum vision aid wherein the at least two frequency filters comprise at least one ¼ wave plates, such as one or more LCDs, preferably one or more multi-domain and/or In Plane Switching LCDs, preferably temperature and/or voltage and/or electrically controlled LCD's.

In an example the present invention relates to a multi spectrum vision aid further comprising a time modulator. Thereby the modulator can be switched on and off. Such further improves the quality and distinction of images obtained.

In an example the present invention relates to a multi spectrum vision aid wherein the modulator comprises one or more of a power supply, such as a battery, a temperature modulator, such as a resistor, an IC for regulating modulation, a temperature sensor, a power sensor, an adaptor for fine tuning, two or more electrodes.

In an example the present invention relates to a multi spectrum vision aid further comprising one or more suspension means, such as a frame. Preferably the frame is of low weight and fits on a human head, such as glasses do.

In an example the present invention relates to a multi spectrum vision aid wherein the frequency filters are adapted to pre-determined use, such as for inspecting, for harvesting and for selecting vegetables, flowers, fruit, and crop, for medical purpose, such as surgical purpose.

In a second aspect the present invention relates to use of the present multi spectrum vision aid for discriminating and/or for selecting elements in a population, such as for inspecting, for harvesting and for selecting vegetables, flowers, fruit, and crop.

In a third aspect the present invention relates to a method for improving yield, according to claim 12.

In an example the present invention relates to a method wherein an object to be yielded is lightened with a selected multi spectrum in order to improve detectability (increase amount of light in a certain spectrum).

In an example the present invention relates to a method wherein one of a stereo image, an image in different spectral areas per eye, and a stereo image illuminated by different spectral areas, is provided.

In an example therein a spectral area is selected from one or more of fluorescence, phosphorescence, UV, near infrared and far infrared. Therewith advantageous colour difference(s) between eyes may be obtained. Also advantages may be taken from after-glow of (part of) an object.

In an example the present invention relates to a method wherein the multi spectral illumination is time modulated.

What is claimed is:

1. A multi spectral vision aid comprising at least two transparent elements, at least one of the at least two transparent elements comprising:
a combined filter comprising:
at least two frequency filters, the at least two frequency filters being substantially different, wherein the at least two filters are adapted to modulate the frequency and/or bandwidth and/or transmittance thereof independently, wherein the at least two frequency filters form a cooperating filter;
wherein the frequency filters operate in a range from 280 nm-2500 nm; and
at least one modulator for modulating the combined filter between at least a first and a second status over a continued period of time, wherein the modulator is operable at a frequency.

2. The multi spectral vision aid according to claim 1, wherein the frequency is from 50 Hz-1000 Hz or from 2-35 Hz.

3. The multi spectral vision aid according to claim 1, wherein the modulator is adapted to alternate between at least three statuses and/or wherein the modulator is adapted to provide an idle status during a period of time in a range of 10 msec-0.5 sec.

4. The multi spectral vision aid according to claim 1, wherein the aid comprises at least two transparent elements.

5. The multi spectral vision aid according to claim 4, further comprising at least one modulator per element for independently modulating an element, wherein the modulator is adapted to modulate the combined filter, one or more of a thermal, an electrical, and/or a chemical supply for the at least one modulator per element, and a driver for directing the at least one modulator.

6. The multi spectral vision aid according to claim 1, wherein the at least two frequency filters comprise at least one ¼ wave plate.

7. The multi spectral vision aid according to claim 1, further comprising a time modulator.

8. The multi spectral vision aid according to claim 1, wherein the modulator comprises one or more of a power supply, a temperature modulator, an IC for regulating modulation, a temperature sensor, a power sensor, an adaptor for fine tuning, and two or more electrodes.

9. The multi spectral vision aid according to claim 1, further comprising one or more suspension device.

10. The multi spectral vision aid according to claim 1, wherein the frequency filters are adapted to a pre-determined use, selected from the group consisting of inspecting, harvesting and selecting one or more of vegetables, flowers, fruit, and crops.

11. A method of using a multi spectral vision aid according to claim 1, comprising discriminating and/or selecting elements in a population selected from the group consisting of vegetables, flowers, fruit, and crops.

12. A method for improving yield, the method comprising the steps of:
providing a multi spectral vision aid;
detecting a spectral difference; and
discriminating and/or selecting elements from a population selected from the group consisting of vegetables, flowers, fruit, and crops.

13. The method according to claim 12, wherein an object to be yielded is lightened with a selected multi spectrum in order to improve detectability.

14. The method according to claim 12, wherein one of a stereo image, an image in different spectral areas per eye, and a stereo image illuminated by different spectral areas, is provided.

15. The method according to claim 14, wherein the multi spectral illumination is time modulated.

16. The multi spectral vision aid according to claim 1, wherein the combined filter additionally comprises a first polarizer.

17. The multi spectral vision aid according to claim 1, additionally comprising an analyzer.

18. The multi spectral vision aid according to claim 1, wherein the frequency filters operate in a range from 400 nm-1600 nm.

19. The multi spectral vision aid according to claim 1, wherein the frequency filters operate in a range from 500 nm-1000 nm.

20. The multi spectral vision aid according to claim 1, wherein the cooperating filter is a tuneable filter.
